(19) United States
(12) Patent Application Publication
(10) Pub. No.: US 2013/0076066 A1
(43) Pub. Date: Mar. 28, 2013

(54) TIRES FLOW CONTROL AND MANAGEMENT SYSTEM

(71) Applicant: Alec C. Wong, Bellevue, WA (US)

(72) Inventor: Alec C. Wong, Bellevue, WA (US)

(73) Assignee: PACCAR INC, Bellevue, WA (US)

(21) Appl. No.: 13/240,912

(22) Filed: Sep. 22, 2011

(51) Int. Cl. B62D 35/02

(52) U.S. Cl. 296/180.4

(57) ABSTRACT

A system for managing airflow around the wheels of a vehicle, and in particular, around dual wheels of trailers typically pulled by Class 8 trucks, is provided. In certain embodiments, a wedge-shaped airflow diverter is provided that reduces drag on the wheels of a trailer pulled by a truck, and thereby improves the overall efficiency of the truck-trailer combination with regard to aerodynamics and fuel efficiency.

### BACKGROUND

The over-the-highway cargo-hauling truck-trailer combination is one vehicle that experiences excessive aerodynamic drag. Generally described, truck-trailer combinations typically include a truck having a so-called fifth wheel by which a box-like semi-trailer may be attached to the tractor by an articulated connection for transportation of the semi-trailer. Numerous means have been sought to improve the fuel-efficiency of truck-trailers by reducing their aerodynamic drag. In the field of surface transportation and, particularly in the long-haul trucking industry, even small improvements in fuel efficiency can reduce annual operating costs significantly. It is therefore advantageous in the design of a vehicle to reduce drag forces, thereby increasing the aerodynamic properties and efficiency of the vehicle.

As a typical pulled semi-trailer moves forward, one source of drag results when air impinges on the leading edges of the trailer wheels. This effect causes excessive drag and reduces vehicle efficiency, making reduction of wheel drag an important area of improvement when designing efficient trailers.

A common method of reducing drag on trailer wheels is to utilize side skirts, which are planar panels that hang down from the longitudinal outer edges of the trailer in-between the rear wheels of the truck and the wheels of the trailer. However, side skirts do not provide a significant aerodynamic benefit to the trailer and they add weight, as well as maintenance and installation costs.

FIGS. 1A and 1B illustrate an exemplary truck-trailer combination having a side skirt 14 depending from the trailer body 12, as known in the prior art. The side skirt 14 extends perpendicular to the underside of the trailer body 12 and is longitudinally parallel to the side of the trailer body 12, as illustrated in FIG. 1B. The side skirt 14 extends nearly the entire length of the trailer 10 between a wheel 18 of the trailer 10 and a wheel 16 of the truck, which pulls the trailer 10. The skirt 14 provides a small aerodynamic benefit to the truck-trailer combination by reducing drag on the rear wheels 18 of the trailer 10. However, because the side skirt extends for a relatively long distance, a significant weight penalty is incurred to the trailer 10. Additionally, the skirt 14 requires upkeep/replacement due to damage commonly sustained during use of the trailer 10.

Shielding fairings placed upstream (in front of) trailer wheels have also been used in an attempt to reduce drag. These shielding fairings are often bullet shaped and direct the flow of air around the wheels. However, known shielding fairings essentially transfer the drag from the wheels to the fairing itself, resulting in little or no actual aerodynamic benefit.

Therefore, an alternative to side skirts and shielding fairings is desired to reduce drag on trailer wheels while possibly reducing total trailer weight. A lighter and more aerodynamic trailer will result in improved fuel efficiency for the truck-trailer combination.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, an airflow diverter is provided that is configured to mount to an underside of a wheeled trailer in a position forward from at least one wheel. In one embodiment, the diverter comprises:

a diverter body having a wedge-like shape and comprising a leading vertical edge, a planar outboard panel extending rearward from the leading vertical edge, and a concavely-curved inboard panel extending rearward from the leading vertical edge;

wherein the leading vertical edge, the planar outboard panel, and the concavely curved inboard panel all extend perpendicular to the underside of the wheeled trailer;

wherein the planar outboard panel has a yaw angle such that a leading portion of the planar outboard panel is further inboard than a trailing portion of the planar outboard panel; and

wherein the concavely-curved inboard panel is configured to direct flow inwardly away from the at least one wheel.

In another aspect, a trailer is provided. In one embodiment, the trailer, comprises:

an axle having first and second ends;

at least one wheel operatively associated with each of the first and second ends of the axle;

a trailer body supported at least in part by at least one wheel;

an air flow diverter mounted to the trailer body at a position proximal the at least one wheel, the diverter comprising a diverter body having a wedge-like shape and comprising a leading vertical edge, a planar outboard panel extending rearward from the leading vertical edge, and a concavely-curved inboard panel extending rearward from the leading vertical edge;

wherein the leading vertical edge, the planar outboard panel, and the concavely curved inboard panel all extend perpendicular to the underside of the wheeled trailer;

wherein the planar outboard panel has a yaw angle such that a leading portion of the planar outboard panel is further inboard than a trailing portion of the planar outboard panel; and

wherein the concavely-curved inboard panel is configured to direct flow inwardly away from the at least one wheel.

In another aspect, a method of reducing drag on at least one wheel supporting a trailer is provided. In one embodiment, the method comprises the steps of:
(a) providing an air flow diverter mounted to the trailer body at a position proximal the at least one wheel, the diverter comprising a diverter body having a wedge-like shape and comprising a leading vertical edge, a planar outboard panel extending rearward from the leading vertical edge, and a concavely-curved inboard panel extending rearward from the leading vertical edge;
wherein the leading vertical edge, the planar outboard panel, and the concavely curved inboard panel all extend perpendicular to the underside of the wheeled trailer;
wherein the planar outboard panel has a yaw angle such that a leading portion of the planar outboard panel is further inboard than a trailing portion of the planar outboard panel; and
wherein the concavely-curved inboard panel is configured to direct flow inwardly away from the at least one wheel; and
(b) moving the trailer in a forward direction.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B illustrate a trailer having a side skirt as known in the prior art, where FIG. 1A is a side elevation view of the trailer and FIG. 1B is a bottom view of the trailer;

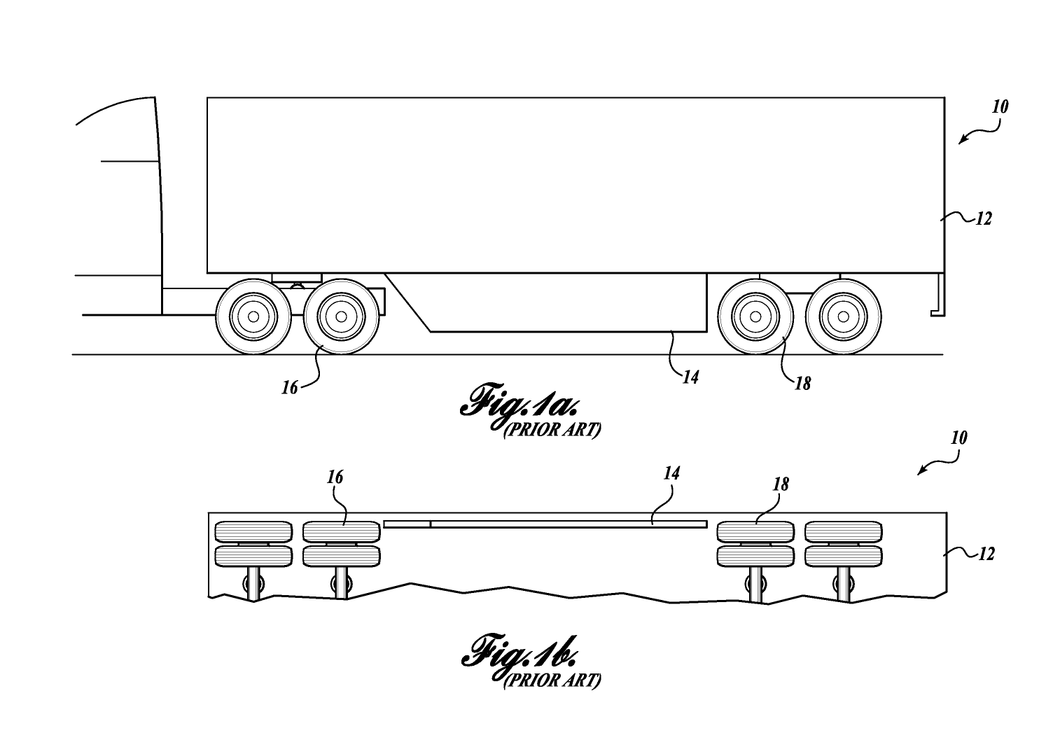

FIG. 2 illustrates one example of a diverter in accordance with aspects of the present disclosure, the direction arranged in relation to a trailer body and an associated rear wheel;

FIG. 3 is a bottom view of the diverter and trailer illustrated in FIG. 2;

FIG. 4 illustrates one example of an elongated diverter in accordance with aspects of the present disclosure;

FIG. 5 illustrates another example of a diverter in accordance with aspects of the present disclosure, wherein the diverter includes a cutout facing the wheels of the trailer;

FIG. 6 is a bottom view of the diverter and trailer illustrated in FIG. 5;

FIG. 7 is a cross-sectional view of the diverter and trailer illustrated in FIG. 6;

FIG. 8 is an isometric view of one example of a diverter attached to a trailer body using a bracket in accordance with aspects of the present disclosure;

FIG. 9 is a bottom view of airflow around a diverter mounted to a trailer in forward motion; and

FIGS. 10A-10D illustrate exemplary axle shields that are mounted to the inboard surface of the diverter in accordance with aspects of the present disclosure.

### DETAILED DESCRIPTION

The embodiments provided herein are directed to a system for managing airflow around the wheels of a vehicle, and in particular, around the wheels of trailers typically pulled by Class 8 trucks. In the embodiments herein, a wedge-shaped airflow diverter is provided for reducing drag on the wheels of a trailer, thereby improving the overall efficiency of the truck-trailer combination (e.g., fuel efficiency is improved). As will be described in more detail below, examples of the diverters are mounted to the underside of a trailer in close proximity to one or more wheels. It will be appreciated that the shape of the diverter directs airflow around the one or more wheels of the trailer, thereby reducing drag.

The diverters provided herein can be mounted to a trailer during original production of the trailer, or can be purchased as an after-market accessory to a trailer and mounted separately from the trailer manufacturing process.

The diverters provided herein are typically made with a strong yet lightweight material such as fiberglass, aluminum polymers, polymer composites, or other rigid material. Representative materials for forming the diverter include molded rubber, polymers, and composites.

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Although embodiments of the present disclosure will be described with reference to Class 8 truck-trailer combinations, one skilled in the relevant art will appreciate that the disclosed embodiments are illustrative in nature, and therefore, should not be construed as limited to application with a Class 8 truck-trailer combination. Additionally, while examples of the trailer depicted herein are shown with tandem axles and dual wheels for each axle, the diverter disclosed herein may be practical with single axle, dual wheels and single axle, single wheels trailers. It should therefore be apparent that the various embodiments have wide application, and may be used in any situation where a reduction in the drag forces acting on a moving body is desirable.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known parts have not been described in detail in order not to unnecessarily obscure various aspects of the present disclosure. Further, it will be appreciated that embodiments of the present disclosure may employ any combination of features described herein.

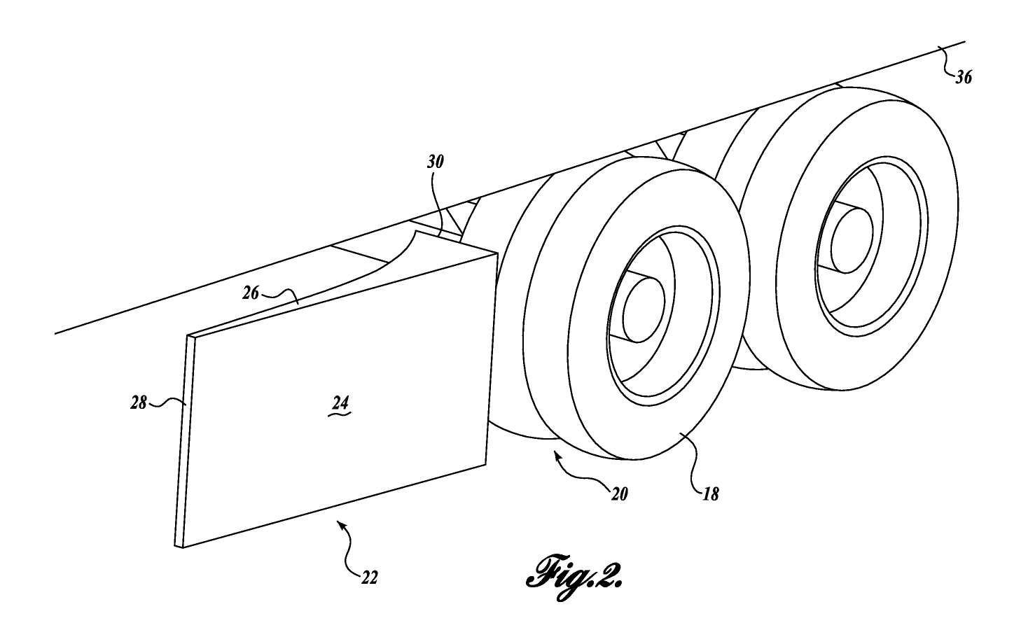

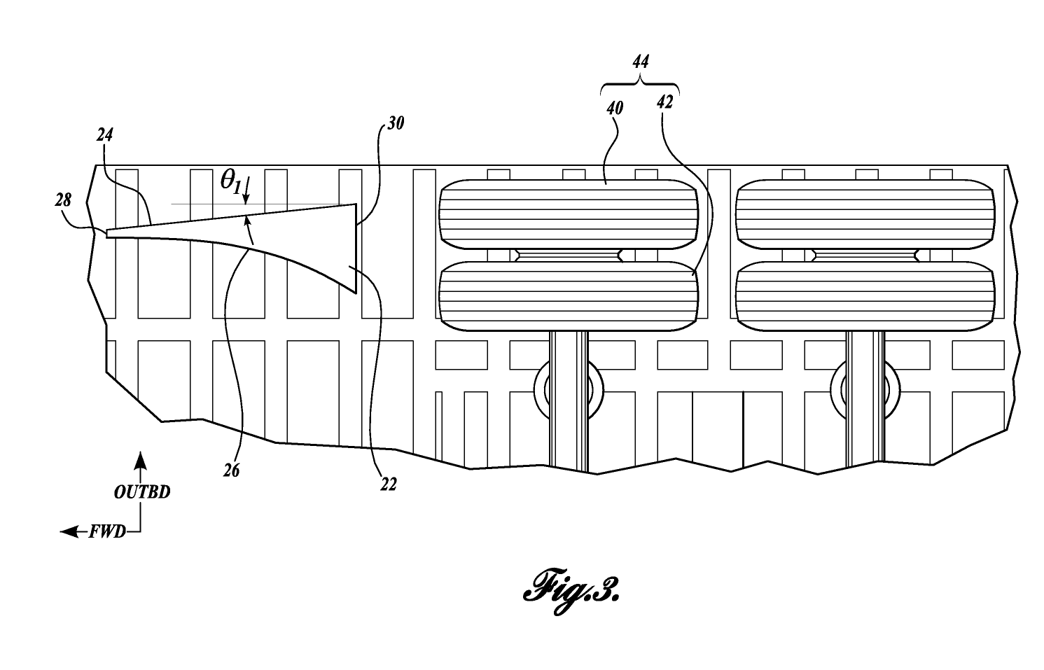

A representative embodiment of the diverter 22 will now be described with reference to FIGS. 2 and 3. As best shown in FIGS. 2 and 3, the diverter 22 depends from the underside of a trailer body 36 in close proximity to one or more wheels, such as an outboard wheel 40 and an inboard wheel 42 (collectively, dual wheels 44) mounted on one side (shown as the left side of the trailer in FIG. 2) of an axle connected to the trailer body 36. The trailer body 36 rides on the dual wheels 44. The diverter 22 comprises a diverter body that includes a planar outboard panel 24, a leading edge 28, a concavely shaped inboard panel 26, and a trailing surface 30. When mounted, the diverter body extends generally perpendicular to the underside of the trailer body 36.

The leading edge 28 of the diverter 22 faces the direction of forward travel of the trailer when in motion. The leading edge 28 can be a sharp edge that comes to a distinct line, a blunt edge, or a curved edge. Unlike known wheel fairings, which typically have a curved leading edge, the diverter 22 has a relatively thin vertical leading edge that splits the airflow between the inboard and outboard sides of the trailer wheels.

The outboard panel 24 of the diverter 22 is a planar panel that extends rearward from the leading edge 28 towards the outboard wheel 40. As can best be seen in FIG. 3, the outboard panel 24 has a yaw angle θ₁ in relation to an axis parallel to the side of the trailer body 36. The yaw angle is such that a leading portion of the outboard panel 24 (i.e., a portion closest to the leading edge 28) is further inboard than a trailing portion of the outboard panel 24. In one embodiment, the yaw angle is from 0 to 20 degrees. The yaw angle is preferable 2 degrees or larger. The yaw angle of the outboard panel 24 is of sufficient size such that air passing over the outboard panel 24 (e.g., during trailer motion) is streamlined around the outboard wheel 40 so as to reduce drag. The outboard panel 24 is tapered from the leading edge 28 and is not symmetric with the inboard panel 26.

Referring still to FIGS. 2 and 3, the concavely curved inboard panel 26 of the diverter 22 is curvilinear as it extends from the leading edge 28 towards the inboard wheel 42. The inboard panel 26 is a deflector surface providing an aerodynamic benefit to the trailer. The curvature of the inboard panel 26 is such that airflow passing across the inboard panel 26 is diverted away from the inboard rear wheel 42 so as to reduce drag when the trailer is in motion. The curvature of the inboard panel 26 is such that air passing over the inboard panel 26 is directed away from the inboard wheel 42. The inboard panel 26 is concavely curved from the leading edge 28 to optimize direction of airflow around the dual wheels 44 and axles.

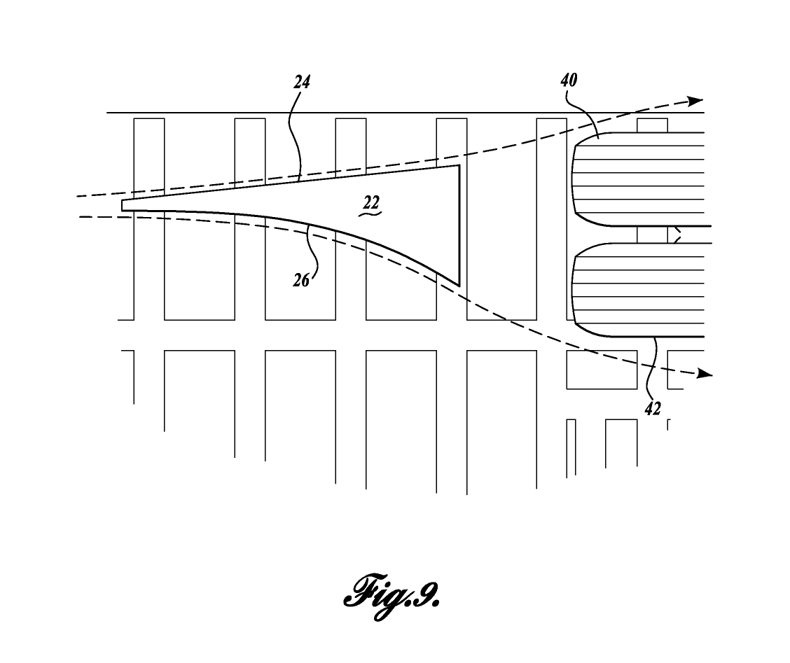

FIG. 9 illustrates the flow of air along the underside of a trailer in forward motion. The airflow, illustrated as dashed lines, is split by the diverter 22 such that a portion of air impacting the diverter 22 is diverted by the outboard panel 24 around the outboard wheel 40. A portion of air impacting the diverter 22 is diverted by the inboard panel 26 around the inboard wheel 42.

The trailing surface 30 of the diverter 22 is typically planar and faces the dual wheels 44. The trailing surface 30 may have a slope such that water projected from the dual wheels 44 impinging on the trailing surface 30 are directed towards the ground. In this regard, the trailing surface 30 may have features on its surface, such as grooves, configured to directed water towards the ground, etc.

The top and bottom surfaces of the diverter 22 are typically flat and smooth so as to minimize drag. It will be appreciated that other drag-reducing surfaces are also contemplated.

Computer simulations indicate that the aerodynamic improvement provided by the diverter 22 reduces drag by about 6% to 10% when mounted to a typical truck-trailer combination moving at 65 miles per hour. For example, an exemplary diverter as described herein was modeled on a computer aerodynamic simulator having a yaw angle of 0 degrees and 2 degrees. Compared to a similar trailer having no diverter, the 0-degree-yaw model reduced drag on the tires by 6.5%; while the 2-degree-yaw model reduced drag on the tires by 9.2%.

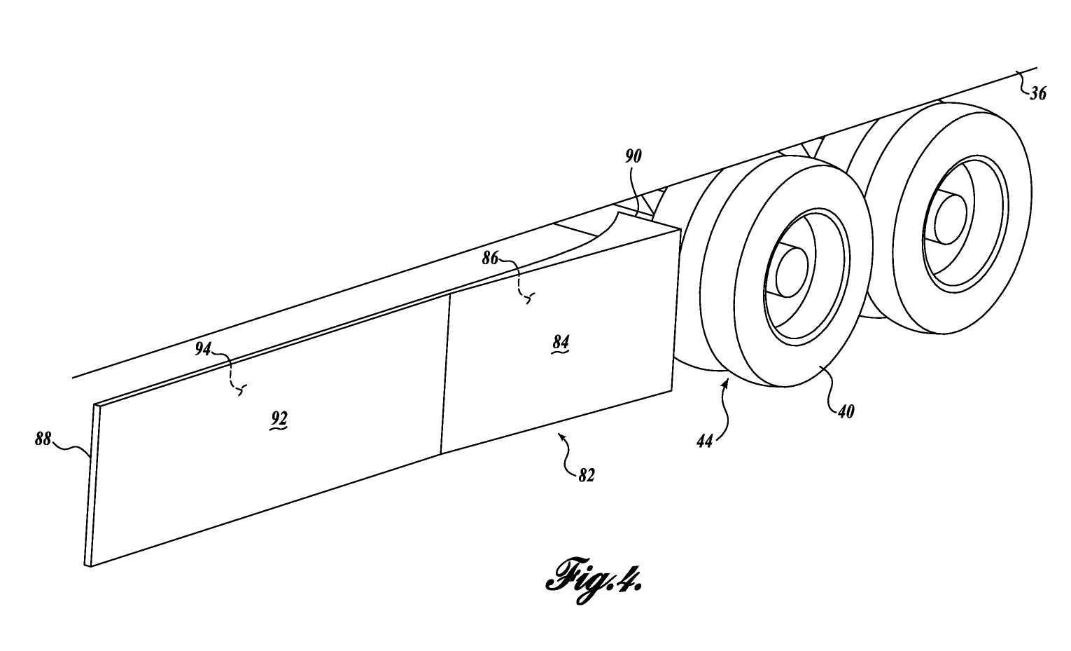

An elongated diverter 82 is provided in an embodiment illustrated in FIG. 4. The elongated diverter 82 is similar in shape and function to the diverter 22 described above. The elongated diverter 82 includes a planar outboard panel 84 having a yaw angle, a concavely shaped inboard panel 86, and a trailing surface 90. The elongated diverter 82 also includes an extension outboard panel 92 and an extension inboard panel 94, both extending rearwardly from the leading edge 88 to the outboard panel 84 and inboard panel 86, respectively. The extension outboard panel 92 of the elongated diverter 82 may be at the same yaw angle as the outboard panel 84, or the two parts may be at different angles. For example, as illustrated in FIG. 4, the extension outboard panel 92 may be parallel to the longitudinal side of the trailer body 36 while the outboard panel 84 is at a yaw angle in relation to the longitudinal direction of the side of the trailer body 36. The angles of the extension outboard panel 92 and the outboard panel 84 contribute to the aerodynamic characteristics of the elongated diverter 82.

The extension inboard panel 94 of the elongated diverter 82 may be curvilinear, similar to the inboard panel 86, or the extension inboard panel 94 may be linear. The curvature (or lack thereof) of the extension inboard panel 92 and the inboard panel 84 contribute to the aerodynamic characteristics of the elongated diverter 82.

The elongated diverter 82 helps to streamline the underbody airflow and to direct the flow around the tires more efficiently, in order to reduce drag. The location of the elongated diverter 82 is not limited to starting from the leading edge of the diverter 82, as shown in FIG. 4. The “extension” portion of the diverter 82 (e.g., the extension inboard and outboard panels 92 and 94) can be longitudinally spaced from the diverter by several inches or feet, as needed to channel the airflow to the diverter 82 in order to optimize drag reduction.

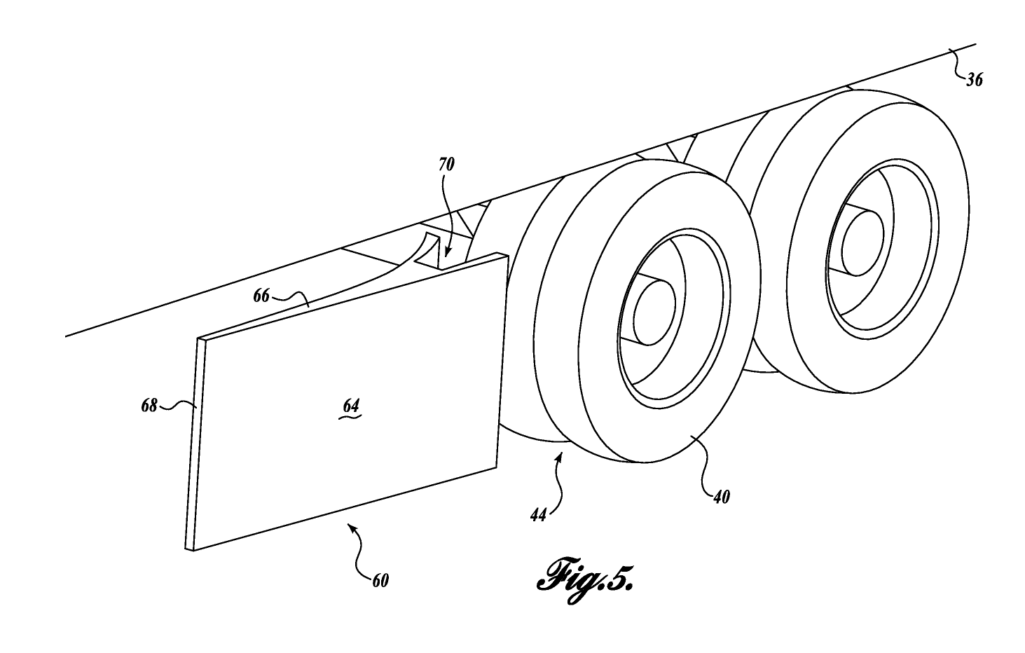

Turning now to FIGS. 5-7, another embodiment of a diverter is illustrated. In this embodiment, the diverter 60 is similar in shape to the diverter 22 described above. In that regard, the diverter 60 includes a planar outboard panel 64 having a yaw angle, a leading edge 68, and a concavely curved inboard panel 66. The diverter 60 also includes a cutout 70 (instead of the trailing surface 30 of the diverter 22 illustrated in FIGS. 2 and 3). The cutout 70 is cut out from the body of the diverter 60 and is configured to receive water projected from the dual wheels 44 during motion of the trailer over a wet surface. By collecting water projected from the wheels, the cutout 70 reduces spray in proximity to the diverter 60 and dual wheels 44, thereby improving drag characteristics of the trailer in motion. The cutout 70 also helps to contain dirt from the road projected by the wheels. By containing dirt within the cutout 70 the surrounding trailer surfaces are kept clean.

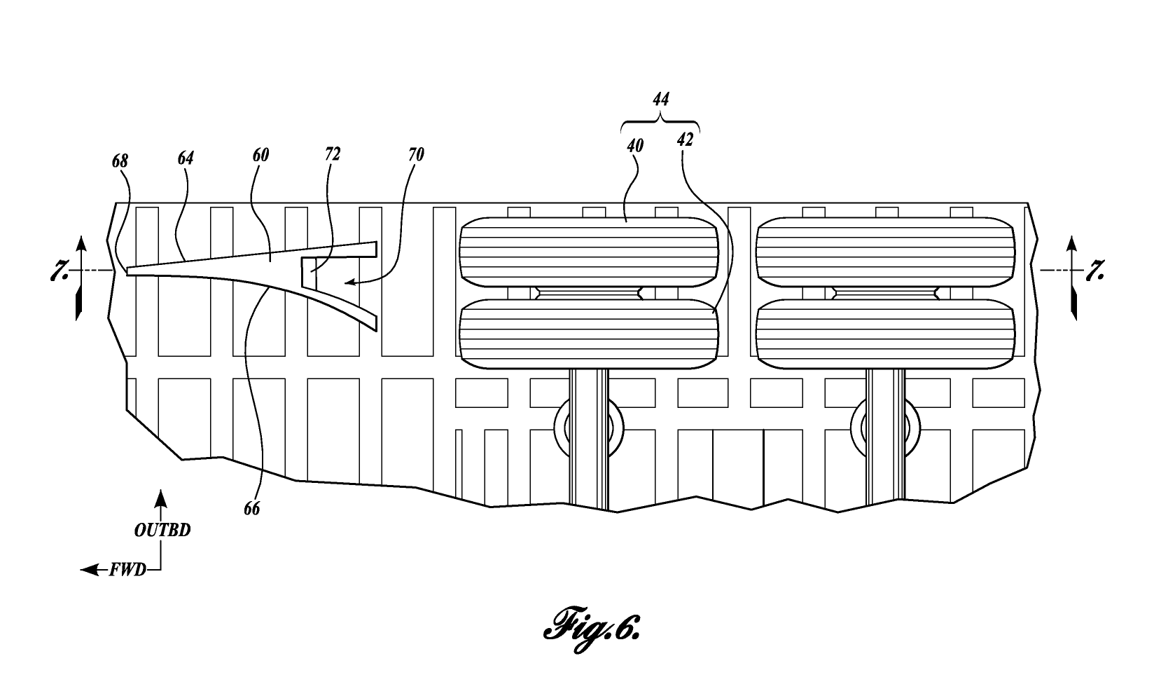

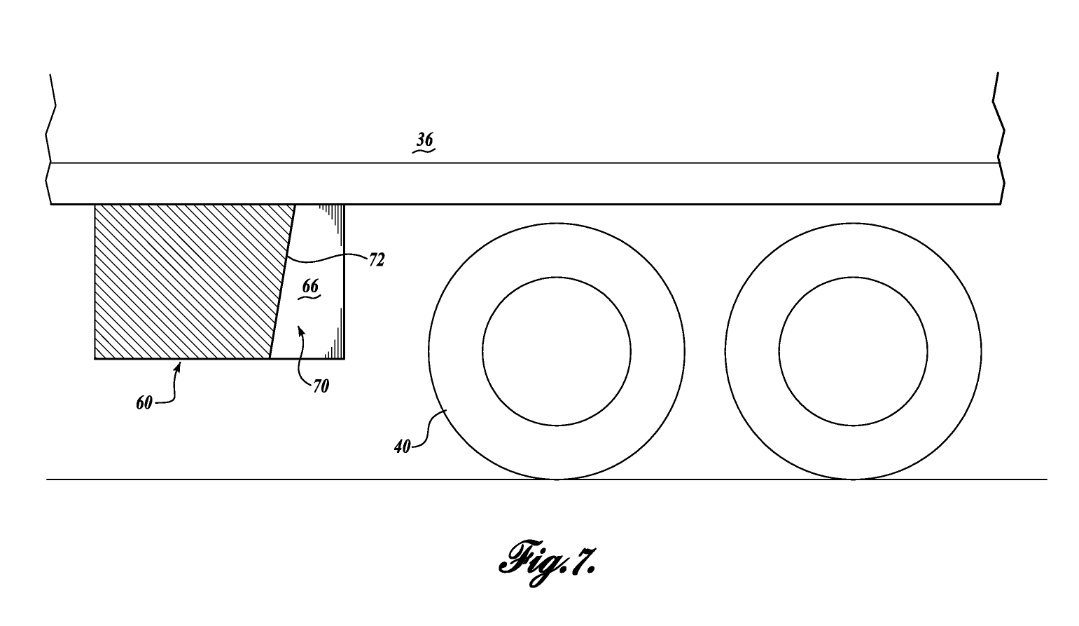

As can best be seen in the embodiment illustrated in FIGS. 6 and 7, the cutout 70 includes a cutout surface 72 that is sloped such that the groundside of the cutout surface 72 forward from the trailer body side of the cutout surface 72. The angle of the cutout surface serves to deflect water thrown from the dual wheels 44 towards the ground.

While a particular embodiment of the cutout 70 having a cutout surface 72 is illustrated in FIGS. 6 and 7, it will be appreciated that the cutout surface 72 need not be planar and need not be at an angle. The cutout surface may be perpendicular to the trailer body 36, may have a rounded shape, and/or may have features on its surface. For example, in one embodiment, the cutout surface 72 includes a plurality of grooves formed in the cutout surface 72 that extend the height of the cutout surface 72 from the trailer body 36 to the bottom of the cutout 70 so as to direct water collected in the cutout 70 towards the ground.

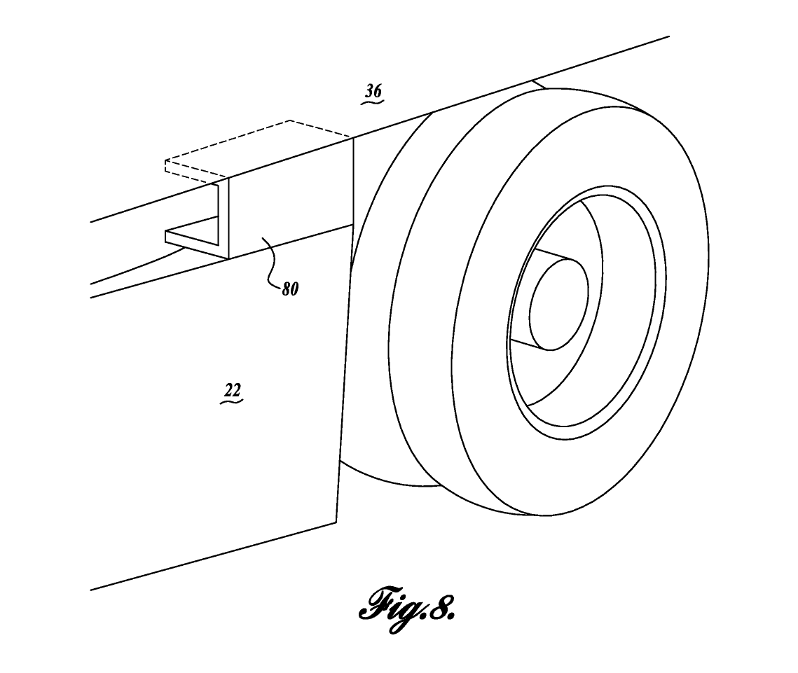

The diverters can be mounted to a trailer body 36 using mountings known to those of skill in the art. Representative mountings include L-brackets fastened to both the diverter 22 and the trailer body, integral mounting flanges extending from the top of the diverter that are bolted or otherwise fastened to the trailer body, and other techniques known to those of skill in the art. As illustrated in FIG. 8, in an exemplary embodiment, the diverter 22 can be mounted to a trailer body 36 using a C-bracket 80 that is attached to both the top surface of the diverter 22 and the bottom side of the trailer body 36. It will be appreciated that any bracket, or attachment means, known to those of skill in the art can be used to mount the diverters.

The diverters are typically configured to be installed with a high ground clearance to minimize fairing damage and maintenance. In one embodiment, the mounted diverter is at least 7 inches from the ground.

The positioning of the diverters with respect to the wheels and the trailer body can be optimized for each truck-trailer to which the diverter is mounted. Given the interconnected aerodynamics between the truck, trailer, and diverter, different trucks pulling the same trailer may have sufficiently different aerodynamics that the diverter can be adjusted for optimal positioning for a particular truck-trailer. To accommodate for the potential need to adjust the positioning of the diverter after installed on a trailer, in certain embodiments a mounting is provided that allows for adjustable positioning of the diverter both longitudinally (i.e., distance from the trailer wheels to the diverter) and with regard to the yaw angle. It will be appreciated that lateral positioning can also be included in the adjustable mounting. Such a mounting may provide the needed degrees of adjustable freedom through a single mounting or a series of mountings (e.g., one mounting adjusts yaw and one mounting adjusts longitudinal position). It will be appreciated that the diverter can also be mounted to be adjusted laterally.

The diverters can have unibody construction (e.g., a single injection-molded plastic diverter) or can be comprised of multiple parts. For example, the panels (e.g., outboard panel 25 and/or inboard panel 26) of the diverter can have a modular design such that specific parts of the diverter can be replaced. A user may desire to replace a specific part of the diverter if that part has been damaged, thereby saving the cost of replacing the entire diverter. Additionally, the characteristics of the diverter may be changed by replacing certain parts. For example, by replacing a first inboard panel 26 to a panel having a different curvature, the aerodynamics of the diverter will be changed. Such customization can be useful, for example, to optimize the diverter aerodynamics for a specific truck-trailer combination. Similarly, the diverters can be configured to allow additional panels to be added to a simple configuration (e.g., diverter 22) to provide an extended diverter configuration (e.g., elongated diverter 82).

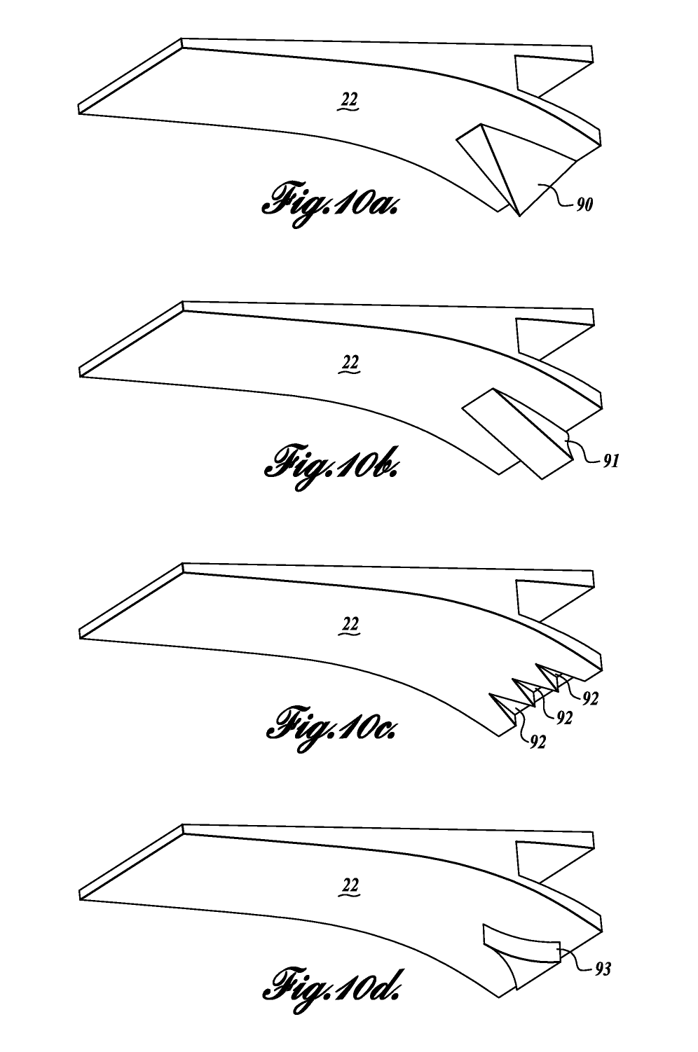

In certain embodiments, illustrated in FIGS. 10A-10D, the diverter 22 is modified to include a projection (e.g., projections 90, 91, and 93) or notches 92, that further affect the airflow around the diverter 22, when in motion. Particularly, the projections and notches are typically arranged on the diverter 22 to be at the same vertical height as the axle connecting the wheels 44. Accordingly, the aerodynamics of the vehicle is further improved by reducing drag on the axle (by way of the projections or notches).

Specifically, FIG. 10A is an embodiment where the projection 90 has a triangular shape such that the base of the triangle abuts the diverter 22 and the peak of the triangle is distal from the diverter.

FIG. 10B is an embodiment where the projection 91 is a rectangular surface that further increases the pitch of a portion of the diverter 22 inboard panel (e.g., at the height of the axle).

FIG. 10C is an embodiment where notches 92 are added to the diverter 22 trailing edge so as to control the flow of air over the inboard panel of the diverter 22.

Finally, FIG. 10D is an embodiment where a projection 93 is shaped and configured to split oncoming air vertically above and below the axle, as air flows across the diverter 22, over the projection 93, and around the axle, so as to further reduce drag.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. An airflow diverter configured to mount to an underside of a wheeled trailer in a position forward from at least one wheel, the diverter comprising:
a diverter body having a wedge-like shape and comprising a leading vertical edge, a planar outboard panel extending rearward from the leading vertical edge, and a concavely-curved inboard panel extending rearward from the leading vertical edge;
wherein the leading vertical edge, the planar outboard panel, and the concavely curved inboard panel all extend perpendicular to the underside of the wheeled trailer;
wherein the planar outboard panel has a yaw angle such that a leading portion of the planar outboard panel is further inboard than a trailing portion of the planar outboard panel; and
wherein the concavely-curved inboard panel is configured to direct flow inwardly away from the at least one wheel.

2. The airflow diverter of claim 1, wherein the yaw angle of the planar outboard panel is an angle from 2 to 20 degrees.

3. The airflow diverter of claim 1, wherein the concavely-curved inboard panel comprises a rectilinear portion and a curvilinear portion.

4. The airflow diverter of claim 1, wherein the leading vertical edge is selected from the group consisting of a sharp edge and a blunt edge.

5. The airflow diverter of claim 1, wherein the diverter is formed from a hard rubber.

6. The airflow diverter of claim 1 further comprising a trailing surface that faces the at least one wheel when the airflow diverter is mounted.

7. The airflow diverter of claim 6, wherein the trailing surface extends perpendicular to the underside of the wheeled trailer.

8. The airflow diverter of claim 6, wherein the trailing surface is a planar panel connecting the trailing portion of the planar outboard panel to a trailing portion of the concavely-curved inboard panel.

9. The airflow diverter of claim 6, wherein the trailing surface comprises a cutout recessed into the airflow diverter, said cutout configured to receive water projected from the at least one wheel during motion of the wheeled trailer over a wet surface.

10. The airflow diverter of claim 9, wherein the cutout comprises vertical groves configured to direct water away from the underside of the wheeled trailer.

11. The airflow diverter of claim 9, wherein the cutout is sloped or curved such that an upper portion of the cutout is closer to the at least one wheel than a lower portion of the cutout.

12. The airflow diverter of claim 1, wherein the at least one wheel is a dual wheel.

13. A trailer, comprising:
an axle having first and second ends;
at least one wheel operatively associated with each of the first and second ends of the axle;
a trailer body supported at least in part by at least one wheel;
an air flow diverter mounted to the trailer body at a position proximal the at least one wheel, the diverter comprising a diverter body having a wedge-like shape and comprising a leading vertical edge, a planar outboard panel extending rearward from the leading vertical edge, and a concavely-curved inboard panel extending rearward from the leading vertical edge;
wherein the leading vertical edge, the planar outboard panel, and the concavely curved inboard panel all extend perpendicular to the underside of the wheeled trailer;
wherein the planar outboard panel has a yaw angle such that a leading portion of the planar outboard panel is further inboard than a trailing portion of the planar outboard panel; and
wherein the concavely-curved inboard panel is configured to direct flow inwardly away from the at least one wheel.

14. The trailer of claim 13, wherein the concavely-curved inboard panel of the airflow diverter comprises a rectilinear portion and a curvilinear portion.

15. The trailer of claim 13, wherein the at least one wheel is a dual wheel.

16. The trailer of claim 13, wherein the airflow diverter is adjustably mounted to the trailer body.

17. A method of reducing drag on at least one wheel supporting a trailer, comprising:
(a) providing an air flow diverter mounted to the trailer body at a position proximal the at least one wheel, the diverter comprising a diverter body having a wedge-like shape and comprising a leading vertical edge, a planar outboard panel extending rearward from the leading vertical edge, and a concavely-curved inboard panel extending rearward from the leading vertical edge;
wherein the leading vertical edge, the planar outboard panel, and the concavely curved inboard panel all extend perpendicular to the underside of the wheeled trailer;
wherein the planar outboard panel has a yaw angle such that a leading portion of the planar outboard panel is further inboard than a trailing portion of the planar outboard panel; and
wherein the concavely-curved inboard panel is configured to direct flow inwardly away from the at least one wheel; and
(b) moving the trailer in a forward direction.

18. The method of claim 17, wherein the concavely-curved inboard panel of the airflow diverter comprises a rectilinear portion and a curvilinear portion.

19. The method of claim 17, wherein the at least one wheel is a dual wheel.

20. The method of claim 17, wherein the airflow diverter is adjustably mounted to the trailer body.
